(19) United States
(12) Patent Application Publication
(10) Pub. No.: US 2026/0312061 A1
(43) Pub. Date: Oct. 8, 2026

(54) POSITIVE ELECTRODE BINDER FOR LITHIUM ION BATTERIES

(71) Applicant: SYENSQO SPECIALTY POLYMERS ITALY S.p.A., Bollate (IT)

(72) Inventors: Francesco Liberale, Pavia (IT); Maurizio Biso, Milano (IT); Riccardo Rino Pieri, Milano (IT); Dominique Teychenne, LA COURNEUVE (FR); Guillaume Gody, RUEIL-MALMAISON (FR)

(73) Assignee: SYENSQO SPECIALTY POLYMERS ITALY S.p.A., Bollate (IT)

(21) Appl. No.: 19/481,736

(22) PCT Filed: May 3, 2024
(86) PCT No.: PCT/EP2024/062313

§ 371 Date: Nov. 5, 2025

(30) Foreign Application Priority Data
May 5, 2023 (EP) 23171873.5

(51) Int. Cl. H01M 4/62; C09J 127/16; H01M 4/02; H01M 4/04; H01M 4/1391; H01M 4/58

(52) U.S. Cl. CPC H01M 4/623; C09J 127/16; H01M 4/0404; H01M 4/1391; H01M 4/5825; H01M 2004/028

(57) ABSTRACT

A positive electrode-forming composition (C) includes at least one positive electrode active material (AM), at least one binder (B), at least one solvent (S); and optionally, at least one electroconductivity-imparting additive. The binder (B) includes a) at least one vinylidene fluoride (VDF) polymer [polymer (F)] and b) at least one branched (meth)acrylic polymer [polymer (A)] derived from the polymerization of at least one (meth)acryloyl monomer [monomer (MAM)] with at least one molecule comprising at least two vinyl groups [monomer (BM)]. The at least one vinylidene fluoride (VDF) polymer includes (i) recurring units derived from VDF; (ii) optionally, recurring units derived from at least one monomer (MA) of formula (I). Monomer (BM) is selected from the group consisting of divinyl aryl monomers; (meth)acrylate diesters; oligo alkylene glycol di(meth)acrylates; divinyl(meth)acrylamides; divinyl ethers; and tetra- or tri-(meth)acrylate esters. Polymer (A) contains less than 1% by moles of monomer (BM).

### TECHNICAL FIELD

The present invention pertains to a binder for Li-ion battery positive electrode, to a method of preparation of said electrode and to its use in a Li-ion battery.

The invention also relates to the Li-ion batteries manufactured by incorporating said electrode.

### BACKGROUND ART

Electrochemical devices such as secondary batteries typically comprise a positive electrode, a negative electrode and an electrolyte.

The electrodes for lithium batteries are usually produced by mixing a binder with a powdery electrode active material.

Fluororesins such as vinylidene fluoride-based polymers have been used as binders for forming positive electrodes. In particular, polyvinylidene fluoride (PVDF) provides a good electrochemical stability and high adhesion to the electrode materials. PVDF is therefore a preferred binder material for electrode slurries.

US 2018/0355206 discloses the use of a copolymer of methyl methacrylate and methacrylic acid in admixture with PVDF for the preparation of LiNMC electrode slurries having good adhesion to the current collector; said mixture has a viscosity that makes it possible to easily spread the active substance over the metal current collector, thus facilitating the manufacture of an electrode for a lithium ion battery.

US 2015/0280238 discloses a stable electrode binder dispersion for use in the preparation of LFP cathodes for lithium ion battery, said dispersion comprising a PVDF dispersed in an organic diluent and a (meth)acrylic polymer dispersant.

The solutions currently available in this field rely on the use of PVDF homopolymers-based binders, which however suffer from poor adhesion to current collectors.

Modified PVDF polymers, such as those comprising recurring units derived from hydrophilic (meth)acrylic monomers (e.g. acrylic acid), are well known in the art. Such copolymers have been developed aiming at adding to the mechanical properties and chemical inertness of PVDF suitable adhesion towards metals, e.g. aluminium or copper.

However, modified PVDF polymers when used in the preparation of a slurry for forming positive electrodes with certain active materials. In particular, in lithium ion batteries, when LiFePO₄ (LFP) active material is used, an important drawback is that the slurry often undergoes to a rapid viscosity increase, leading to the formation of a gel, thus preventing their use as binder for LPF cathodes.

A time dependency in the rheological properties of the composite electrode slurries is observed also in sodium-ion secondary batteries; in fact, gelation of the slurry can be initiated by the NaOH present on the material when exposed to air, with consequent dehydrofluorination with crosslinking of PVDF. Said gelation leads to inhomogeneous coatings being produced.

The need for more performing polymers, which guarantee in particular better mechanical performance and higher adhesion to current collectors, is still felt both in research and from industrial perspectives.

One way is to find a blend of polymers which therefore avoids the drawbacks of PVDF homopolymer and of modified PVDF polymers in contact with certain active materials such as LFP, but which at the same time guarantees the feasibility of electrodes through wet casting and high adhesions of the final product.

In addition, the need in the industry is felt for polymers having improved resistance, in particular in terms of swelling resistance, when put in contact with the battery electrolyte, especially in the case of using carbonates-based electrolytes.

The present invention provides a positive electrode-forming composition capable of preventing gelation while, at the same time, enabling the manufacturing of electrodes having enhanced adhesion, reduced polymer swelling in contact with the electrolyte, lower resistivity, electrochemical stability and longer battery life.

### SUMMARY OF INVENTION

It is thus an object of the invention a positive electrode-forming composition (C) comprising
at least one positive electrode active material (AM) and
at least one binder (B), wherein binder (B) comprises:
   a) at least one vinylidene fluoride (VDF) polymer [polymer (F)] that comprises:
(i) recurring units derived from VDF;
(ii) optionally, recurring units derived from at least one monomer (MA) of formula (I):

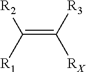

wherein:
R₁, R₂ and R₃, equal to or different from each other, are independently selected from a hydrogen atom and a C₁-C₃ hydrocarbon group, and
Rx is a C₁-C₂₀ hydrocarbon moiety comprising at least one functional group selected from a hydroxyl, a carboxyl, an epoxide, an ester, a phosphate and an ether group, in an amount of from 0.05 to 10% by moles of with respect to the total moles of recurring units of polymer (F);
   b) at least one branched (meth)acrylic polymer [polymer (A)] derived from the polymerization of at least one (meth)acryloyl monomer [monomer (MAM)] with at least one molecule comprising at least two vinyl groups [monomer (BM)], wherein monomer (BM) is selected from the group consisting of divinyl aryl monomers such as divinyl benzene; (meth)acrylate diesters such as alkylene di(meth)acrylates such as ethylene glycol di(meth)acrylate, propylene glycol di(meth)acrylate, 1,4-butylene glycol di(meth)acrylate; oligo alkylene glycol di(meth)acrylates such as e.g. tetraethyleneglycol di(meth)acrylate, poly(ethyleneglycol) di(meth)acrylate, poly (propyleneglycol) di(meth)acrylate; divinyl (meth)acrylamides such as methylene bisacrylamide; divinyl ethers such as poly(ethyleneglycol)divinyl ether; and tetra- or tri-(meth)acrylate esters such as pentaerythritol tetra (meth) acrylate, trimethyloIpropane tri(meth)acrylate or glucose di- to penta (meth)acrylate, and
   wherein polymer (A) contains less than 1% by moles of monomer (BM);
at least one solvent (S); and
optionally at least one electroconductivity-imparting additive.

In a second instance, the present invention pertains to the use of the electrode-forming composition (C) of the invention in a process for the manufacture of a positive electrode for electrochemical devices [electrode (E)], said process comprising:
(i) providing a metal substrate having at least one surface;
(ii) providing an electrode-forming composition (C) as defined above;
(iii) applying the composition (C) onto the at least one surface of the metal substrate, thereby providing an assembly comprising a metal substrate coated with said composition (C) onto the at least one surface;
(iv) drying the assembly provided in step (iii).

In a third instance, the present invention pertains to the positive electrode (E) obtainable by the process of the invention.

In a fourth instance, the present invention pertains to an electrochemical device comprising a positive electrode (E) of the present invention.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

The terms “acrylic” and “acrylate” are used interchangeably (unless to do so would alter the intended meaning) and include acrylic acids and derivatives thereof. The terms “(meth)acrylic” or “(meth)acrylate” are intended to cover both the acrylic/acrylate and methacrylic/methacrylate forms of the indicated material, e.g., a (meth)acrylate monomer.

The electrode active material (AM) of the positive electrode is preferably a compound capable of intercalating lithium ions or sodium ions.

The conventional active materials (AM) at the positive electrode of sodium-ion batteries are generally selected from Na-based layered transition-metal oxides, Prussian blue analogs and polyanion-type materials.

In some embodiments the active materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is ⅔.

In some embodiments the active materials are Prussian blue analogs (PBA) of general formula AₓP[R(CN)₆]_{1-y}·mH₂O, with A being and alkali metal ion, P being a N-coordinated transition metal ion, R being a C-coordinated transition metal ion, y being a [R(CN)₆] vacancy, with 0≤x≤2 and 0≤y<1, such as Na_{0.81}Fe[Fe(CN)₆]_{0.79}, NaFe₂(CN)₆, Na_{1.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCo₁₋ₓFe(CN)₆ with 0≤x≤1 e.g. Na₂CoFe(CN)₆.

In some other embodiments the active materials are polyanion-type materials of general formula NaₓM_{y}(XO₄)ₙ (where X=S, P, Si, As, Mo and W, and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x≤4, M=V, Fe, Ni, Mn, Ti, Cr, Zr; X=P, S, Si, Se, Mo—with single transition metal type such as Na₃V₂(PO₄)₃ (NVP), Na₃Cr₂(PO₄)₃, Na₃Fe₂(PO₄)₃; —with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with ⅔≤x≤⅞ e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro sulfates such as NaMSO₄F (with M=Fe, Co, Ni); mixed phosphates/pyrophosphates of general formula Na₄M₃(PO₄)₂(P₂O₇) (with M representing transition metals) such as Na₄Mn₃(PO₄)₂(P₂O₇), Na₄Co₃(PO₄)₂(P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCo₂₋ₓ(SO₄)₃, Na₂₊₂ₓMn₂₋ₓ(SO₄)₃ (where 0≤x≤1); silicates of general formula Na₂MSiO₄ (with M=Mn, Fe, Co and Ni).

In some preferred embodiments the active materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF).

The conventional active materials (AM) at the positive electrode of lithium-ion batteries may comprise a composite metal chalcogenide of formula LiMQ₂, wherein M is at least one metal selected from transition metals such as Co, Ni, Fe, Mn, Cr and V and Q is a chalcogen such as 0 or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0≤x≤1) and spinel-structured LiMn₂O₄.

As an alternative, still, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material has formula Li₃₋ₓM′_{y}M″_{2-y}(JO₄)₃ wherein 0≤x≤3, 0<y≤2, M′ and M″ are the same or different metals, at least one of which being a transition metal, JO₄ is preferably P04 which may be partially substituted with another oxyanion, wherein J is either S, V, Si, Nb, Mo or a combination thereof. Still more preferably, the electrode active material (AM) is a phosphate-based electro-active material of formula LiₓA_{y}D_{z}PO₄,
wherein A is selected from the group consisting of Mn, Fe, Co, Ni and Cu;
D is selected from the group consisting of Mg, Ca, Sr, Ba; x, y and z are numbers that satisfy the following relationships: 0<x<2, 0<y<1.5, 0≤z<1.5.

The A component is preferably Fe, Mn, and Ni, and particularly preferably Fe.

The D component is preferably Mg or Ca.

Examples of the compound having an olivine structure include lithium iron phosphate (LFP), lithium iron manganese phosphate (LMFP) and lithium manganese phosphate.

Further, as the positive electrode active material (AM), it is possible to use a material whose surface is partially or wholly covered with carbon in order to supplement the conductivity.

The amount of carbon coated is preferably 20 parts by weight or less, more preferably 10 parts by weight or less, still more preferably 5 parts by weight or less, based on 100 parts by weight of the positive electrode active material.

The compound having an olivine structure is present in composition (C) in an amount of 70% by mass or more, with respect to 100% by mass of the entire positive electrode active material (AM).

More preferably, it is 90% by mass or more, and most preferably, the positive electrode active material (AM) is composed only of a compound having an olivine structure.

Most preferably, the positive electrode active material (AM) consists only of lithium iron phosphate (LFP).

In the positive electrode composition of the present invention, the active material (AM) has an average particle size of 3 μm or less.

The average particle size (D50) of the compound having an olivine structure is more preferably in the range of from 0.01 to 1.8 μm.

The average particle size of the positive electrode active material can be measured by a particle size distribution meter for dynamic light scattering.

As the average particle size becomes smaller, the surface area becomes larger and the binder must be bound with a small amount of the binder, so that the flexibility of the binder is required.

By using a positive electrode active material containing a compound having an olivine structure having an average particle size of 3 μm or less, the electrical characteristics such as the output characteristics when the positive electrode composition for a secondary battery is used as the positive electrode of the battery are excellent.

Composition (C) of the invention further comprises binder (B) comprising:
a) at least one vinylidene fluoride (VDF) copolymer [polymer (F)]
b) at least one branched (meth)acrylic polymer [polymer (A)];
c) at least one solvent (S); and
d) optionally at least one electroconductivity-imparting additive.

The polymer (F) comprises recurring units derived from vinylidene fluoride (VDF) and optionally recurring units derived from at least one monomer (MA) of formula (I)

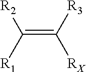

wherein:
   R₁, R₂ and R₃, equal to or different from each other, are independently selected from a hydrogen atom and a C₁-C₃ hydrocarbon group, and
   Rx is a C₁-C₂₀ hydrocarbon moiety comprising at least one functional group selected from a hydroxyl, a carboxyl, an epoxide, an ester, a phosphate and an ether group,
   in an amount of from 0.05 to 10% by moles of with respect to the total moles of recurring units of polymer (F).

More preferably, the monomer (MA) preferably complies with formula (II):

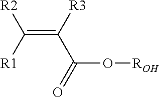

wherein each of R1 and R2 have the meanings as above defined, R3 is hydrogen, and R_{OH} is a hydrogen or a C₁-C₅ hydrocarbon moiety comprising at least one hydroxyl group and/or at least a carboxylic group; more preferably, each of R1, R2, R3 are hydrogen, while R_{OH} has the same meaning as above detailed.

Non limitative examples of monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

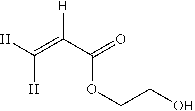

2-hydroxypropyl acrylate (HPA) of either of formulae:

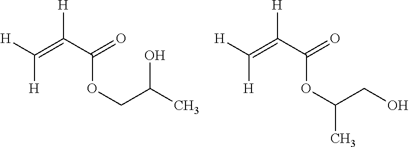

acrylic acid (AA) of formula:

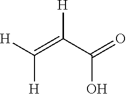

and mixtures thereof.

Most preferably, the monomer (MA) is AA or HEA.

Polymer (F) may still comprise other moieties such as defects, end-groups and the like, which do not affect nor impair its physico-chemical properties.

Polymer (F) is semi-crystalline. The term semi-crystalline is intended to denote a polymer (F) which possesses a detectable melting point. It is generally understood that a semi-crystalline polymer (F) possesses a heat of fusion determined according to ASTM D 3418 of advantageously at least 0.4 J/g, preferably of at least 0.5 J/g, more preferably of at least 1 J/g.

Polymer (F) is preferably a linear copolymer, that is to say, it is composed of macromolecules made of substantially linear sequences of recurring units from VDF monomer and (MA) monomer; polymer (F) is thus distinguishable from grafted and/or comb-like polymers.

Polymer (F) comprises at least 0.05% by moles, more preferably at least 0.1% by moles, even more preferably at least 0.2% by moles of recurring units derived from said monomer (MA).

Polymer (F) comprises preferably at most 2% by moles, more preferably at most 1.8% by moles, even more preferably at most 1.5% by moles of recurring units derived from said monomer (MA).

In a preferred embodiment of the invention, in polymer (F) the recurring units derived from monomer (MA) of formula (I) are comprised in an amount of from 0.2 to 1% by moles with respect to the total moles of recurring units of polymer (F).

The polymer (F) has advantageously an intrinsic viscosity, measured in dimethylformamide at 25° C., of above 0.15 I/g and at most 0.60 I/g, preferably in the range of 0.20-0.50 I/g, more preferably comprised in the range of 0.25-0.40 I/g.

The polymer (F) may further comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂=CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

In one embodiment of the invention, polymer (F) comprises from 0.1 to 10.0% by moles, preferably from 0.3 to 5.0% by moles, more preferably from 0.5 to 3.0% by moles of recurring units derived from said fluorinated comonomer (CF).

The polymer (F) more preferably comprises recurring units derived from:
at least 70% by moles, preferably at least 75% by moles, more preferably at least 85% by moles of vinylidene fluoride (VDF),
from 0.2% to 1% by moles, of a monomer (MA) of formula (I);
optionally from 0.5 to 3.0% by moles of recurring units derived from at least one fluorinated comonomer (CF).

The polymer (F) may be obtained by polymerization of a VDF monomer, at least one monomer (MA) and optionally at least one comonomer (CF), either in suspension in organic medium, according to the procedures described, for example, in WO 2008/129041, or in aqueous emulsion, typically carried out as described in the art (see e.g. U.S. Pat. Nos. 4,016,345, 4,725,644 and 6,479,591).

The procedure for preparing the polymer (F) in suspension comprises polymerizing in an aqueous medium in the presence of a radical initiator the vinylidene fluoride (VDF) monomer, monomer (MA) and optionally comonomer (CF), in a reaction vessel, said process comprising
continuously feeding an aqueous solution comprising monomer (MA); and
maintaining the pressure in said reactor vessel exceeding the critical pressure of the vinylidene fluoride.

During the whole suspension polymerization run, pressure is maintained above critical pressure of vinylidene fluoride. Generally, the pressure is maintained at a value of more than 50 bars, preferably of more than 75 bars, even more preferably of more than 100 bars.

The expressions “continuous feeding”, “adding continuously” or “continuously feeding” means that slow, small, incremental additions of the aqueous solution of monomer (MA) take place until polymerization has concluded.

The polymer (F) thus obtained has a high uniformity of monomer (MA) distribution in the polymer backbone, which advantageously maximizes the effects of the modifying monomer (MA) on both adhesiveness and/or hydrophilic behaviour of the resulting copolymer.

In addition, the Applicant has surprisingly found that the presence of the monomer (MA) uniformly distributed in the polymer (F) has the effect of improving the thermal stability of VDF copolymers, which otherwise is unsatisfactorily low, in particular lower than that of VDF homopolymers.

The at least one branched (meth)acrylic polymer (A), different from polymer (F), is a polymer comprising recurring units derived from at least one (meth)acryloyl monomer [monomer (MAM)] with at least one branching monomer, which is a molecule comprising at least two vinyl groups [monomer (BM)].

Polymer (A) is a copolymer. By “copolymer” as used herein it is intended to denote a polymer having two or more different monomer units. The copolymer could be a terpolymer with three or more different monomer units, or have four or more different monomer units. The copolymer may be a random copolymer, a gradient copolymer, or a block copolymer formed by a controlled polymerization process. Preferably, the copolymer is formed by a free radical polymerization process or an anionic polymerization process, and the process can be any polymerization method known in the art, including but not limited to emulsion, solution, suspension polymerization, and can be done in bulk, and semi-bulk.

The term (meth)acryloyl monomer (MAM) refers to the monomer having a (meth)acryloyl group in the molecule.

Suitable (meth)acryloyl monomers (MAM) are hydrophobic (meth)acryloyl monomers that may for example, be chosen from (meth)acrylamide acid esters of formula CH₂=C(R)—C(═O)—NH—Rh, or (meth)acrylic acid esters of formula CH₂=C(R)—C(═O)—O—Rh wherein R means hydrogen or an alkyl group with 1 to 3 carbon atoms and Rh means a linear or branched alkyl residue with 1 to 30 carbon atoms, preferably with 1 to 15 carbons, more preferably with 1 to 5 carbons.

Non-limited examples of such monomers are methyl (meth)acrylate, ethyl (meth)acrylate, n-propyl(meth)acrylate, isopropyl(meth)acrylate, n-butyl (meth)acrylate, methoxy ethyl (meth)acrylate, 2-ethoxy ethyl (meth)acrylate, tert-butyl (meth)acrylate, pentyl (meth)acrylate, heptyl (meth)acrylate, 2-tert-butylheptyl (meth)acrylate, octyl (meth)acrylate), iso-octyl (meth)acrylate, nonyl (meth)acrylate, decyl (meth)acrylate, undecyl (meth)acrylate, 5-methylundecyl (meth)acrylate, dodecyl (meth)acrylate, isobornyl (meth)acrylate, norbornyl (meth)acrylate, cycloalkyl (meth)acrylate, like cyclohexyl(meth)acrylate, phenyl (meth)acrylate.

Polymer (A) may also include recurring units derived from other alpha, beta-ethylenically unsaturated monomers bearing functionalities such as carboxyl groups or substituted alkyl esters.

Suitable alpha, beta-ethylenically unsaturated monomers bearing functionalities can be selected from hydrophilic (meth)acryloyl monomer, such as monoethylenically unsaturated monocarboxylic acid and derivatives. This include, among others, acrylic acid, methacrylic acid (MAA), hydroxyethyl(meth)acrylate, hydroxypropyl(meth)acrylate, hydroxyethylhexyl(meth)acrylate, crotonic acid, 2-carboxyethyl acrylate oligomers such as Sipomer®B-CEA.

The expression “methylmethacrylate polymer” is used within the frame of the present invention for designating a polymer made of recurring units, wherein more than 50% by moles of said recurring units being derived from methylmethacrylate (MMA).

Preferred (meth)acrylic polymers (A) for use in composition (C) of the present invention are methylmethacrylate polymers.

In a preferred embodiment of the present invention, polymer (A) is a methylmethacrylate polymer that contains at least 50% by moles of methylmethacrylate monomer units, preferably at least 70% by moles of methylmethacrylate monomer units.

According to said preferred embodiment, polymer (A) may contain from 1 to 45, preferably 3 to 30, and more preferably 5 to 20% by moles of at least one co-monomer copolymerizable with methylmethacrylate, including but not limited to monomers (MAM) as above defined, or other alpha, beta-ethylenically unsaturated monomers bearing functionalities such as carboxyl groups or substituted alkyl esters.

Polymer (A) contains at least one branching monomer (BM).

According to the present invention, a branching monomer is a monomer that during the polymerization can react at least in two different positions, resulting in branched chain growth.

During the preparation of polymer (A), the (meth)acryloyl monomer (MAM) may grow in the polymerization reaction in two directions, reacting with another (meth)acryloyl monomer or with the branching monomer.

According to the present invention, the branching monomer (BM) is a molecule comprising at least two vinyl groups. The branching monomer (BM) may also comprise more than two vinyl groups. These vinyl groups are suitable for polymerization in an addition polymerization reaction. Many of such molecules are readily available, or may be prepared by reacting any di- or multifunctional molecule with a suitably reactive vinylic reactant. Examples include di- or multivinyl esters, di- or multivinyl amides, di- or multivinyl aryl compounds (including those with heterocyclic aryl groups), and di- or multivinyl alkyl/aryl ethers.

Branching monomers (BM) are selected from the group consisting of divinyl aryl monomers, such as divinyl benzene; (meth)acrylate diesters such as alkylene di(meth)acrylates such as ethylene glycol di(meth)acrylate, propylene glycol di(meth)acrylate, 1,4-butylene glycol di(meth)acrylate; oligo alkylene glycol di(meth)acrylates such as e.g. tetraethyleneglycol di(meth)acrylate, poly(ethyleneglycol) di(meth)acrylate, poly (propyleneglycol) di(meth)acrylate; divinyl (meth)acrylamides such as methylene bisacrylamide; divinyl ethers such as poly(ethyleneglycol)divinyl ether; and tetra- or tri-(meth)acrylate esters such as pentaerythritol tetra (meth) acrylate, trimethyloIpropane tri(meth)acrylate or glucose di- to penta (meth)acrylate.

Preferred branching monomers are divinyl benzene, α,ω-alkylene di(meth)acrylates or divinyl (meth)acrylamides, most preferred may be α,ω-alkylene di(meth)acrylates such as ethylene glycol di(meth)acrylate and 1,4-butylene glycol di(meth)acrylate or divinyl (meth)acrylamides, such as methylene bisacrylamide.

More preferably, the branching monomer (BM) is divinyl benzene (DVB).

Polymer (A) contains less than 1% by moles of the at least one branching monomer (BM), preferably from 0.2 to less than 1% by moles of the at least one branching monomer (BM).

The Applicant has surprisingly found that the presence in polymer (A) of the at least one branching monomer (BM) in an amount lower than 1% by moles allows to obtain a solution of polymer (A) in solvent (S). With higher amounts of monomer (BM) in polymer (A), solubility of said polymer (A) in solvent (S) could be an issue.

The branched (meth)acrylic polymer (A) is prepared by polymerizing a mixture of at least one hydrophilic (meth)acryloyl monomer (MAM) with at least one monomer (BM), optionally in the presence of other alpha, beta-ethylenically unsaturated monomers bearing functionalities such as carboxyl groups or substituted alkyl esters.

When the branched (meth)acrylic polymer (A) includes hydrophilic (meth)acryloyl monomer such as monoethylenically unsaturated monocarboxylic acid, said polymer (A) may further be at least partially salified to obtain at least a fraction of the acidic moieties in the form of a salt.

In an embodiment of the present invention, it is thus provided a branched (meth)acrylic polymer (A) that is at least partially salified.

The preparation of branched (meth)acrylic polymer (A) may thus further include a step of neutralization of at least a fraction of acid groups with a salt [salt (SA)] including a monovalent cation in a suitable solvent.

The salt (SA) can be any salt capable of neutralizing the acid groups, and it is preferably selected from a salt capable of providing an alkali metal cation, a tertiary or quaternary ammonium cation, more preferably Na⁺, K⁺, Li⁺ and or quaternary ammonium cation.

The polymer (A) for use in the composition (C) of the present invention preferably has a number average molecular weight (Mn) of at least 1 kDa, for example between 1 and 150 kDa. More preferably, the polymer (A) has a number average molecular weight (Mn) between 15 and 100 kDa.

The polymer (A) for use in the composition (C) of the present invention preferably has a weight average molecular weight (Mw) of about 1 kDa to 150 kDa, preferably from 5 kDa to 100 kDa.

In one embodiment of the present invention, polymer (A) is a methylmethacrylate polymer comprising 100% by moles of methylmethacrylate monomer units (methylmethacrylate homopolymer).

According to another preferred embodiment, polymer (A) is a methylmethacrylate copolymer comprising at least 70% by moles of methylmethacrylate monomer units, up to 20% by moles of methacrylic acid monomer units and less than 1% by moles of branching monomer (BM).

The choice of the solvent (S) is not particularly limited, provided that it is suitable for solubilising polymer (F) and polymer (A).

Solvent (S) is typically selected from the group consisting of:
alcohols such as methyl alcohol, ethyl alcohol and diacetone alcohol,
ketones such as acetone, methylethylketone, methylisobutyl ketone, diisobutylketone, cyclohexanone and isophorone,
linear or cyclic esters such as isopropyl acetate, n-butyl acetate, methyl acetoacetate, dimethyl phthalate and γ-butyrolactone,
linear or cyclic amides such as N,N-diethylacetamide, N,N-dimethylacetamide, dimethylformamide and N-methyl-2-pyrrolidone, and
dimethyl sulfoxide.

The electrode forming compositions of the present invention may further include one or more optional electroconductivity-imparting additives in order to improve the conductivity of an electrode made from the composition of the present invention. Electroconductivity-imparting additives for batteries are known in the art.

Examples thereof may include: carbonaceous materials, such as carbon black, graphite fine powder carbon nanotubes, graphene, or fiber, or fine powder or fibers of metals such as nickel or aluminum. The optional conductive agents are preferably carbon black or carbon nanotubes.

The amount of optional conductive agent is preferably from 0 to 30% by weight with respect to the total solids in the electrode forming composition. In particular, for positive electrode forming compositions the optional conductive agent is typically from 0% by weight to 10% by weight, more preferably from 0% by weight to 5% by weight of the total amount of the solids within the composition (C).

Composition (C) may further comprise at least one wetting agent and/or at least one surfactant and one or more than one additional additives.

Composition (C) may further comprise at least one non-electroactive inorganic filler material.

By the term “non-electroactive inorganic filler material”, it is hereby intended to denote an electrically non-conducting inorganic filler material, which is suitable for the manufacture of an electrically insulating separator for electrochemical cells.

The non-electroactive inorganic filler material in the separator according to the invention typically has an electrical resistivity (φ of at least 0.1×1010 ohm cm, preferably of at least 0.1×1012 ohm cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

Binder (B) for use in the composition (C) according to the present invention can be prepared by any known method in the art. A suitable method comprises:
dissolving polymer (F) with a solvent (S),
dissolving polymer (A) with a solvent (S), preferably the same used to dissolve polymer (F), and
mixing the two solutions to provide a binder solution (B).

The weight ratio of polymer (F) to polymer (A) in binder (B) is conveniently in the range of from 95:5 to 70:30. In a preferred embodiment of the invention, the weight ratio of polymer (F) to polymer (A) in binder (B) is 90:10.

The electrode-forming composition (C) may be obtained by adding and dispersing a powdery electrode material, and optional additives, such as an electroconductivity-imparting additive and/or a viscosity modifying agent, into the thus-obtained binder solution (B), to obtain a homogeneous slurry.

The solution of polymer (F) in solvent (S) is notably comprising the polymer (F) in an amount of from 5 to 20% by weight, preferably about 7 to 10% by weight.

The solution of polymer (A) in solvent (S) is notably comprising the polymer (A) in an amount of from 5 to 10% by weight in 100 parts by weight of such a solvent.

For obtaining the binder solution (B) comprising polymer (F) and polymer (A) as above detailed, it is preferred to dissolve separately the polymer (F) is solvent (S) and from 5 to 10% by weight of the polymer (A) in 100 parts by weight of such a solvent.

In order to prepare the binder solution (B), it is preferred to dissolve the polymer (F) and polymer (A) in a solvent (S) at a temperature of 20-50° C.

Alternatively, the binder solution (B) can be prepared by first dissolving polymer (F) in solvent (S), followed by addition of solid polymer (A) to the mixture prepared thereof.

The total solid content (TSC) of the composition (C) of the present invention is typically comprised between 15 and 70% by weight, preferably from 40 to 60% by weight over the total weight of the composition (C). The total solid content of the composition (C) is understood to be cumulative of all non-volatile ingredients thereof, notably including polymer (F), polymer (A), the electrode active material and any solid, non-volatile additional additive.

When the solutions of polymer (F) and of polymer (A) are prepared separately and subsequently combined with an electrode active material and optional conductive material and other additives to prepare composition (C), an amount of solvent sufficient to create a stable solution is employed. The amount of solvent used may range from the minimum amount needed to create a stable solution to an amount needed to achieve a desired total solid content in an electrode mixture after the active electrode material, optional conductive material, and other solid additives have been added.

Mixing of the two solutions is carried out by any known method in the art, such as by planetary mixing followed by dispersion phase.

The presence of polymer (A) in the composition (C) makes it possible to obtain homogeneous slurry compositions with no gelation evidence in all the preparation steps. Thus, it is possible to use of polymers (F) bearing polar groups in electrode-forming composition comprising the olivine type active material electrodes, and exploiting the properties of such polymers in electrodes, such as the greater adhesion to current collector, the improved flexibility and the good mechanical performances.

In addition, polymer (A) acts as a dispersant in binder compositions, and reduces the slurry viscosity versus compositions having the same TSC but comprising a polymer (F), an active material and an electroconductivity-imparting additive only.

Another advantage of the composition (C) of the present invention is that it is possible to provide an electrode which comprises a relatively low content by weight of binder and to make it possible to increase the content of active material in the positive electrode, in order to maximise the capacity of the battery.

The electrode-forming composition (C) of the invention can be used in a process for the manufacture of a positive electrode [electrode (E)], said process comprising:
(i) providing a metal substrate having at least one surface;
(ii) providing an electrode-forming composition [composition (C)] as above defined;
(iii) applying the composition (C) onto the at least one surface of the metal substrate, thereby providing an assembly comprising a metal substrate coated with said composition (C) onto the at least one surface;
(iv) drying the assembly provided in step (iii).

The metal substrate is generally a foil, mesh or net made from a metal, such as from aluminium, nickel, titanium, and alloys thereof.

In step (iii) of the process of the invention, the electrode forming composition (C) is applied onto at least one surface of the metal substrate typically by any suitable procedures such as casting, printing and roll coating.

Optionally, step (iii) may be repeated, typically one or more times, by applying the electrode forming composition (C) provided in step (ii) onto the assembly provided in step (iv).

In step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

The dried assembly obtained in step (iv) may further be submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 2 and 3 g/cc, preferably at least 2.1 g/cc. The density of electrode (E) is calculated as the sum of the product of the densities of the components of the electrode multiplied by their mass ratio in the electrode formulation.

In a further aspect, the present invention pertains to the electrode [electrode (E)] obtainable by the process of the invention.

Therefore the present invention relates to an electrode (E) comprising:
a metal substrate having at least one surface, and
directly adhered onto at least one surface of said metal substrate, at least one layer consisting of a composition [composition (C′)] comprising:
a) at least one positive electrode active material (AM);
b) a binder composition [binder (B′)] comprising:
   b′) at least one polymer (F) as above defined,
   b″) at least one polymer (A) as above defined;
c) optionally, at least one electroconductivity-imparting additive.

The composition (C′) directly adhered onto at least one surface of said metal substrate corresponds to the electrode forming composition (C) of the invention wherein the solvent has been at least partially removed during the manufacturing process of the electrode, for example in step (iv) (drying) and/or in the further compression step. Therefore all the preferred embodiments described in relation to the electrode forming compositions (C) of the invention are also applicable to the composition (C′) directly adhered onto at least one surface of said metal substrate, in electrodes of the invention, except for the aqueous medium removed during the manufacturing process.

The preferred positive electrode (E) comprises:
a metal substrate having at least one surface, and
directly adhered onto at least one surface of said metal substrate, at least one layer consisting of:
j) a positive electrode active material (AM) having an olivine structure in an amount from 90 to 98% by weight;
jj) the binder (B′) in an amount from 0.5 to 10% by weight, preferably from 1 to 5% by weight; and
jjj an electroconductivity-imparting additive in an amount from 0.5 to 5% by weight,
wherein the above mentioned % by weight are in respect to the total weight of j)+jj)+jjj).

Preferably, the positive electrode (E) comprises of at least 95% by weight of active material (AM) and an electrode loading comprised between 8 and 20 mg/cm2, preferably of about 15 mg/cm2.

Advantageously, the electrode (E) according to the present invention is excellent in electrolyte swelling resistance.

The electrode (E) of the invention is particularly suitable for use in electrochemical devices, in particular in secondary batteries, showing reduced polymer swelling when in contact with electrolyte, lower resistivity and longer battery life.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

The invention will be now described with reference to the following examples, whose purpose is merely illustrative and not intended to limit the scope of the invention.

### Experimental Section

### Raw Materials

Polymer (F-1): VDF-AA (1.0% by moles) polymer having an intrinsic viscosity of 0.30 I/g in DMF at 25° C.
MMA: methylmethacrylate, commercially available from Sigma-Aldrich
MAA: methacrylic acid, commercially available from Sigma-Aldrich
DVB: divinyl benzene, commercially available from Sigma-Aldrich
AMBN: 2,2′-azobis(2-methylbutyronitrile), commercially available from Sigma-Aldrich
Nano-LFP: LFP DY-3, density: 3.53 g/cm³, practical specific capacity: 153 mAh/g, commercially available from Shenzhen Dynanonic Co., Ltd.
Carbon nanotubes: Orgacyl NMP0402. 4% thin multiwall carbon nanotube (MWCNT) in N-Methyl-2-pyrrolidone (NMP) solvent.

### Preparation 1: Polymer (A-1): Poly(MMA-MAA-DVB) 79.8/20/0.2 Mol % in NMP

In a 2 L jacketed reactor equipped with a multi-stage lightning A320 stirring blade, counter-blades, a condenser connected to a minichiller and a cryothermostatic bath were introduced, at room temperature, MMA (24.864 g, 0.246 mol), MAA (5.358 g, 0.061 mol), DVB (0.100 g, 0.616 mmol, 80% purity), AMBN (2.821 g, 0.014 mol) and 414.583 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (140.89 g, 1.393 mol), MAA (30.36 g, 0.349 mol) and DVB (0.568 g, 3.492 mmol, 80% purity) was prepared. Once the temperature of 75° C. was reached in the reactor, the monomer solution, previously prepared, was introduced over 1 hour. After completion of the addition, the reaction was aged at 75° C. for an additional time of 6 hours. Finally, the reaction was diluted up to 25.40 wt % with NMP, cooled down to room temperature and the reactor was discharged. Conversions to monomers MMA, MAA and DVB were found to be nearly quantitative (>99%) by ¹H NMR (done in CDCl₃).

### Preparation 2: Polymer (A-2): Poly(MMA-MAA-DVB) 79.5/20/0.5 Mol % in NMP

In a 2 L jacketed reactor equipped with a multi-stage lightning A320 stirring blade, counter-blades, a condenser connected to a minichiller and a cryothermostatic bath were introduced, at room temperature, MMA (27.747 g, 0.245 mol), MAA (5.353 g, 0.062 mol), DVB (0.250 g, 1.539 mmol, 80% purity), AMBN (2.818 g, 0.014 mol) and 599.089 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (140.235 g, 1.387 mol), MAA (30.33 g, 0.349 mol) and DVB (1.419 g, 8.721 mmol, 80% purity) was prepared. Once the temperature of 75° C. was reached in the reactor, the monomer solution, previously prepared, was introduced over 1 hour. After completion of the addition, the reaction was aged at 75° C. for an additional time of 6 hours. Finally, the reaction was diluted up to 10.7 wt % with NMP, cooled down to room temperature and the reactor was discharged. Conversions to monomers MMA, MAA and DVB were found to be nearly quantitative (>99%) by ¹H NMR (done in CDCl₃).

### Preparation 3: Polymer (A-3): Poly(MMA-MAA-DVB) 79.65/20/0.35 Mol % in NMP

In a 2 L jacketed reactor equipped with a multi-stage lightning A320 stirring blade, counter-blades, a condenser connected to a minichiller and a cryothermostatic bath were introduced, at room temperature, MMA (14.734 g, 0.147 mol), MAA (3.181 g, 0.037 mol), DVB (0.105 g, 0.647 mmol, 80% purity), AMBN (1.658 g, 8.623 mmol) and 658.175 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (83.495 g, 0.834 mol), MAA (18.028 g, 0.209 mol) and DVB (0.596 g, 3.665 mmol, 80% purity) was prepared. Once the temperature of 75° C. was reached in the reactor, the monomer solution, previously prepared, was introduced over 1 hour. After completion of the addition, the reaction was aged at 75° C. for an additional time of 6 hours. Finally, the reaction was cooled down to room temperature and the reactor was discharged. Conversions to monomers MMA, MAA and DVB were found to be nearly quantitative (>99%) by ¹H NMR (done in CDCl₃). A solid content equal to 14.54 wt % was measured.

### Preparation 4: Polymer (A-4): Poly(MMA-MAA-DVB) 79.5/20/0.5 Mol % in NMP

In a 2 L jacketed reactor equipped with a multi-stage lightning A320 stirring blade, counter-blades, a condenser connected to a minichiller and a cryothermostatic bath were introduced, at room temperature, MMA (14.700 g, 0.147 mol), MAA (3.180 g, 0.037 mol), DVB (0.150 g, 0.923 mmol, 80% purity), AMBN (1.657 g, 8.618 mmol) and 658.141 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (83.299 g, 0.832 mol), MAA (18.019 g, 0.209 mol) and DVB (0.852 g, 5.233 mmol, 80% purity) was prepared. Once the temperature of 75° C. was reached in the reactor, the monomer solution, previously prepared, was introduced over 1 hour. After completion of the addition, the reaction was aged at 75° C. for an additional time of 6 hours. Finally, the reaction was cooled down to room temperature and the reactor was discharged. Conversions to monomers MMA, MAA and DVB were found to be nearly quantitative (>99%) by ¹H NMR (done in CDCl₃). A solid content equal to 14.58 wt % was measured.

### Preparation 5: Polymer (A-5): Poly(MMA-MAA-DVB) 79.25/20/0.75 Mol % in NMP

In a 2 L jacketed reactor equipped with a multi-stage lightning A320 stirring blade, counter-blades, a condenser connected to a minichiller and a cryothermostatic bath were introduced, at room temperature, MMA (14.642 g, 0.146 mol), MAA (3.177 g, 0.037 mol), DVB (0.225 g, 1.384 mmol, 80% purity), AMBN (1.656 g, 8.612 mmol) and 658.083 g of NMP. The mixture was purged with nitrogen for 20 minutes at room temperature and under stirring, after the nitrogen flow was left in the sky, the temperature of the cryothermostatic bath was programmed at 75° C. over a temperature ramp of 1 hour. In parallel, a solution of monomers MMA (82.974 g, 0.829 mol), MAA (18.005 g, 0.209 mol) and DVB (1.276 g, 7.843 mmol, 80% purity) was prepared. Once the temperature of 75° C. was reached in the reactor, the monomer solution, previously prepared, was introduced over 1 hour. After completion of the addition, the reaction was aged at 75° C. for an additional time of 6 hours. Finally, the reaction was cooled down to room temperature and the reactor was discharged. Conversions to monomers MMA, MAA and DVB were found to be nearly quantitative (>99%) by ¹H NMR (done in CDCl₃). A solid content equal to 14.00 wt % was measured.

### Preparation 6: PMMA Polymer: MMA Homopolymer Solution in DMF Solution

In a 500 mL three necked round bottom flask equipped with a reflux condenser and a mechanical agitation, 15.15 g (0.15 mol) of MMA, 1.37 g (7.12 mmol) of AMBN and 123.63 g of DMF were introduced at room temperature. The mixture was purged with nitrogen for 15 minutes at room temperature and then immersed in an oil bath preheated at 80° C. After stabilizing the temperature at 75° C. in the mass, 85.86 g (0.86 mol) of MMA was added to the reaction mixture over 1 hours using a syringe pump. After completion of the addition, the reaction was let stirring for an additional time of 6 hours. After this final ageing step, the mixture was cooled down to ambient temperature. Finally, a dilution was carried out to bring the product to a solution having solid content of of 34.61%.

A sample was taken for ¹H NMR analysis to determine the MMA monomer conversion (¹H NMR in CDCl₃): >99%.

### Example 1

A 8% by weight solution of polymer (F-1) in NMP was prepared.

A 8% by weight solution of polymer (A-1) in NMP was prepared starting from the solution of polymer (A-1) in NMP obtained in Preparation 1 above

The solution of polymer (F-1) in NMP and the solution of polymer (A-1) in NMP were mixed in a 9:1 ratio (30.87 g of solution of polymer (F-1) and 3.43 g of solution of polymer (A-1)).

Nano-LFP (75.07 g), carbon nanotubes (14.7 g of solution at 4% wt in NMP) and additional 15.94 g of NMP were added to the solution comprising polymer (F-1) and polymer (A-1) with planetary mixing followed by dispersion phase to provide COMPOSITION 1, a cathode slurry having a Total Solid Content (TSC) of 56% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Comparative Example 1

A 8% by weight solution of HSV900 in NMP was prepared.

Nano-LFP (75.07 g), carbon nanotubes (14.7 g of solution at 4% wt in NMP) and additional 15.94 g of NMP were added to 34.3 g of the solution comprising HSV900 with planetary mixing followed by dispersion phase to provide COMPOSITION (C-1), a cathode slurry having a Total Solid Content (TSC) of 56% and an amount of binder of 3.5%.

### Comparative Example 2

A 8% by weight solution of polymer (F-1) in NMP was prepared.

A 8% by weight solution of PMMA polymer in NMP was prepared starting from the solution of PMMA polymer in NMP obtained in Preparation 6 above:

The solution of polymer (F-1) in NMP and the solution of PMMA polymer in NMP were mixed in a 9:1 ratio (30.87 g of solution of polymer (F-1) and 3.43 g of solution of PMMA polymer.

Nano-LFP (75.07 g), carbon nanotubes (14.7 g of solution at 4% wt in NMP) and additional 15.94 g of NMP were added to the solution comprising polymer (F-1) and PMMA polymer with planetary mixing followed by dispersion phase to provide COMPOSITION (C-2), a cathode slurry having a Total Solid Content (TSC) of 56% (95.75% LFP, 0.75% carbon nanotubes and 3.5% binder).

Results of visual evaluation of slurry quality are summarized at Table 1.

TABLE 1

| COMPOSITION | Slurry Quality* |
|---|---|
| 1 | A |
| C-1 | A |
| C-2 | A |

*A = good: visual homogeneous aspect at rest and under manual stirring. No evidence of agglomerates, nor phase separation, nor deposits on the
container's walls.
B = medium: the slurry seems homogenous. Evidence of small agglomerates, e.g. solid particles not perfectly dispersed, small gels or thin deposit on the bottom or on the walls of the becker. Slurry casting not prevented.
C = bad: not homogeneous slurry, with macroscopic evidences. Gels or solid agglomerates are present. Slurry viscosity can be too high to allow casting and further mixing can be prevented/limited due to solid block (gel-like) formation. If phase separation happens, too low viscosity in the upper part and solid bottom layer.

### Example 4: Electrode-Forming Compositions Gelation Evaluation

Viscosity of the compositions 1, C-1 and C-2 immediately after their preparation (t₀ viscosity) was measured, detecting −50% viscosity for the composition obtained in Example 1 vs those from Comparative Examples 1 and Comparative Example 2 (this last 2 compositions show comparable values).

The results are reported in Table 2.

TABLE 2

| | Viscosity |
|---|---|
| COMPOSITION | at t₀*** |
| 1 | 0.5 |
| C-1 | 1 |
| C-2 | 1 |

***normalized vs C-1 t₀ viscosity

Over time, viscosity change was qualitatively monitored, not highlighting gelation issues and making slurry castability feasible after a few hours/days

### Example 5: Preparation of Electrodes

Positive electrodes were obtained by applying the electrode-forming compositions as above described to 15 μm thick aluminium foils so as to obtain a mass of dry positive electrode loading of 15 mg/cm². The solvent was completely evaporated by drying in an oven at temperature of 90° C. to fabricate a strip-shaped positive electrodes.

The positive electrodes so obtained (electrode (E1), (EC-1), (EC-2), were visually evaluated. The results are reported in Table 3.

TABLE 3

| ELECTRODE | Electrode quality** |
|---|---|
| E1 | A |
| EC-1 | A |
| EC-2 | A |

**A = good: smooth aspect, no evidence of agglomerates on the dried electrode, nor inhomogeneity due to bubbles formation and evaporation. Manual handling was easy, electrodes have good flexibility when slightly bended and folded, with no evidence of active material cracking or detachment.
B = medium: electrodes have an average homogeneous aspect. With accurate visual observation or with optical microscope, small agglomerates are detected. No material detachment nor cracking with gentle bending
C = bad: macroscopic inhomogeneity on the electrode surface (e.g. solid particles dragged during casting). Material cracked or detached from current collector without handling. Not possible to be punched/cut for further characterization

### Positive Electrodes Adhesion Evaluation

Positive electrodes (E1), (EC-1) and (EC-2) were cut in stripes (10 cm long and 2.5 cm wide) and applied onto rigid aluminium foils having thickness of 2 mm, using a biadhesive tape of dimensions 2.5×8 cm, with the coated side of the electrode facing the aluminium plate. A portion of the electrode was kept from adhering to the tape, thus leaving one end of each stripe not in contact with the biadhesive tape, allowing for its pulling from the foil.

Each specimen was pulled from the foil at an angle of 1800 by a dynamometer that allowed the measurement of the force needed to peel off the sample from the biadhesive tape. Peeling speed is 300 mm/min, with T=25° C. The results are summarized in Table 4.

TABLE 4

| | Peeling Strength |
|---|---|
| | (N/m)**** |
| (E1) | 6.4 |
| (EC-1) | 1 |
| (EC-2) | 5.3 |

****Normalized to EC-1

It has been demonstrated that the electrodes of the invention have an improved adhesion to metal foil in comparison with standard electrodes of the prior art comprising PVDF.

1. A positive electrode-forming composition (C) comprising:
at least one positive electrode active material (AM) and
at least one binder (B), wherein binder (B) comprises:
a) at least one vinylidene fluoride (VDF) polymer [polymer (F)] that comprises:
(i) recurring units derived from VDF;
(ii) optionally, recurring units derived from at least one monomer (MA) of formula (I): 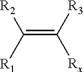
wherein:
R₁, R₂ and R₃, equal to or different from each other, are independently selected from a hydrogen atom and a C₁-C₃ hydrocarbon group, and
Rx is a C₁-C₂₀ hydrocarbon moiety comprising at least one functional group selected from the group consisting of a hydroxyl, a carboxyl, an epoxide, an ester, a phosphate, and an ether group,
in an amount of from 0.05 to 10% by moles of with respect to the total moles of recurring units of polymer (F);
b) at least one branched (meth)acrylic polymer [polymer (A)] derived from the polymerization of at least one (meth)acryloyl monomer [monomer (MAM)] with at least one molecule comprising at least two vinyl groups [monomer (BM)], wherein monomer (BM) is selected from the group consisting of divinyl aryl monomers; (meth)acrylate diesters; oligo alkylene glycol di(meth)acrylates; divinyl (meth)acrylamides; divinyl ethers; and tetra- or tri-(meth)acrylate esters, and
wherein polymer (A) contains less than 1% by moles of monomer (BM);
at least one solvent (S); and
optionally, at least one electroconductivity-imparting additive.

2. The composition (C) according to claim 1, wherein the monomer (MA) is selected from the group consisting of acrylic acid, methacrylic acid, hydroxyethyl (meth)acrylate, hydroxypropyl(meth)acrylate, hydroxyethylhexyl(meth)acrylate, and combinations thereof.

3. The composition (C) according to claim 1, wherein the active material (AM) has the following formula:
LiₓA_{y}D_{z}PO₄,
wherein A is selected from the group consisting of Mn, Fe, Co, Ni, Cu, and combinations thereof; D is selected from the group consisting of Mg, Ca, Sr, Ba, and combinations thereof; x, y and z are numbers that satisfy the following relationships: 0<x<2, 0<y<1.5, 0≤z<1.5.

4. The composition according to claim 1, wherein the active material (AM) is selected from lithium iron phosphate (LFP), lithium iron manganese phosphate (LMFP) and lithium manganese phosphate.

5. The composition (C) according to claim 1, wherein polymer (A) comprises recurring units derived from at least one (meth)acryloyl monomer (MAM) selected from the group consisting of (meth)acrylamide acid esters of formula CH₂=C(R)—C(═O)—NH—Rh, or (meth)acrylic acid esters of formula CH₂=C(R)—C(═O)—O—Rh, wherein R is hydrogen or an alkyl group with 1 to 3 carbon atoms and Rh is a linear or branched alkyl residue with 1 to 30 carbon atoms.

6. The composition according to claim 5, wherein the at least one (meth)acryloyl monomer (MAM) is selected from the group consisting of methyl (meth)acrylate, ethyl (meth)acrylate, n-propyl(meth)acrylate, isopropyl(meth)acrylate, n-butyl (meth)acrylate, methoxy ethyl (meth)acrylate, 2-ethoxy ethyl (meth)acrylate, tert-butyl (meth)acrylate, pentyl (meth)acrylate, heptyl (meth)acrylate, 2-tert-butylheptyl (meth)acrylate, octyl (meth)acrylate), iso-octyl (meth)acrylate, nonyl (meth)acrylate, decyl (meth)acrylate, undecyl (meth)acrylate, 5-methylundecyl (meth)acrylate, dodecyl (meth)acrylate, isobornyl (meth)acrylate, norbornyl (meth)acrylate, cycloalkyl (meth)acrylate, cyclohexyl(meth)acrylate, phenyl (meth)acrylate, and combinations thereof.

7. The composition (C) according to claim 1, wherein polymer (A) further comprises recurring units at least one hydrophilic (meth)acryloyl monomer selected from the group consisting of acrylic acid, methacrylic acid (MAA), hydroxyethyl(meth)acrylate, hydroxypropyl(meth)acrylate, hydroxyethylhexyl(meth)acrylate, crotonic acid, 2-carboxyethyl acrylate oligomers, and combinations thereof.

8. The composition (C) according to claim 1, wherein polymer (A) is a methylmethacrylate polymer that contains at least 70% by moles of methylmethacrylate monomer units, up to 20% by moles of methacrylic acid monomer units, and less than 1% by moles of monomer (BM).

9. The composition (C) according to claim 1, wherein polymer (A) is at least partially salified.

10. The composition (C) according to claim 1, wherein the weight ratio of polymer (F) to polymer (A) in binder (B) is in the range of from 95:5 to 70:30.

11. A process for the manufacture of a positive electrode [electrode (E)], the process comprising:
(i) providing a metal substrate having at least one surface;
(ii) providing an electrode-forming composition [composition (C)] claim 1;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii).

12. A positive electrode (E) obtained by the process according to claim 11.

13. A positive electrode (E) comprising:
a metal substrate having at least one surface, and
directly adhered onto at least one surface of said metal substrate, at least one layer consisting of:
j) a positive electrode active material (AM) in an amount from 90 to 98% by weight;
jj) a binder (B′) that comprises
b′) at least one vinylidene fluoride (VDF) copolymer [polymer (F)] that comprises:
(i) recurring units derived from VDF;
(ii) recurring units derived from at least one monomer (MA) of formula (I): 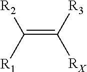
wherein:
R₁, R₂ and R₃, equal to or different from each other, are independently selected from a hydrogen atom and a C₁-C₃ hydrocarbon group, and
Rx is a C₁-C₂₀ hydrocarbon moiety comprising at least one functional group selected from a hydroxyl, a carboxyl, an epoxide, an ester and an ether group,
in an amount of from 0.05 to 10% by moles of with respect to the total moles of recurring units of polymer (F);
b″) at least one branched (meth)acrylic polymer [polymer (A)]; and
optionally at least one electroconductivity-imparting additive,
the binder (B′) is present in an amount from 0.5 to 10% by weight; and
jjj) an electroconductivity-imparting additive in an amount from 0.5 to 5% by weight, wherein the above mentioned % by weight are in respect to the total weight of j)+jj)+jjj).

14. An electrochemical device comprising the electrode (E) according to claim 13.

15. The composition (C) of claim 1, wherein the monomer (BM) is selected from the group consisting of divinyl benzene, alkylene di(meth)acrylates, tetraethyleneglycol di(meth)acrylate, poly(ethyleneglycol) di(meth)acrylate, poly (propyleneglycol) di(meth)acrylate, methylene bisacrylamide, poly(ethyleneglycol)divinyl ether, pentaerythritol tetra (meth) acrylate, trimethylolpropane tri(meth)acrylate, glucose di- to penta (meth)acrylate, and combinations thereof.

16. The composition (C) of claim 15, wherein the alkylene di(meth)acrylates comprise one or more selected from ethylene glycol di(meth)acrylate, propylene glycol di(meth)acrylate, and 1,4-butylene glycol di(meth)acrylate.

17. The composition (C) according to claim 5, wherein Rh is the linear or branched alkyl residue with 1 to 15 carbons.

18. The composition (C) according to claim 5, wherein Rh is the linear or branched alkyl residue with 1 to 5 carbons.

19. The composition (C) according to claim 1, wherein the weight ratio of polymer (F) to polymer (A) in binder (B) is in the range of from 90:10.

20. The positive electrode (E) according to claim 13, wherein the binder (B′) is present in an amount from 1 to 5% by weight.
